(19) United States
(12) Patent Application Publication
(10) Pub. No.: US 2019/0072659 A1
(43) Pub. Date: Mar. 7, 2019

(54) Artificial-Intelligence Controlled Adaptive Multi-Purpose Beam Forming Automobile Radar

(71) Applicants: RICHARD GU, Plano, TX (US); Tiejun Shan, Plano, TX (US)

(72) Inventors: RICHARD GU, Plano, TX (US); Tiejun Shan, Plano, TX (US)

(21) Appl. No.: 15/698,417

(22) Filed: Sep. 7, 2017

(51) Int. Cl. G01S 13/72; G01S 13/93

(52) U.S. Cl. CPC G01S 13/726; H01Q 3/2682; G01S 13/931

(57) ABSTRACT

A radar system to track objects for a vehicle may include a plurality of transmitters to transmit a signal; a plurality of receivers to receive the signal; and an adjustment circuit to adjust the bandwidth of the transmitted signal in accordance with the received signal from the receivers of the radar system.

### FIELD OF THE INVENTION

The present invention is related to an adaptive digital beam forming and steering system which may be mounted in a mobile or stationary body such as a vehicle such as a automobile, truck, motorcycle, bicycle or other such device to detect the direction of a target object such as an obstacle or other vehicle and its distance and velocity relative to the mobile body.

### BACKGROUND OF THE INVENTION

Traditional advanced driver-assistance systems (ADAS) are capable of adaptively tracking and following cars on straight road, but lack the capability of tracking and following cars effectively on curved road or at the corner of the intersections.

### SUMMARY OF THE INVENTION

A radar system to track objects for a vehicle may include a plurality of transmitters to transmit a signal; a plurality of receivers to receive the signal; and an adjustment circuit to adjust the bandwidth of the transmitted signal in accordance with the received signal from the receivers of the radar system,

The adjustment circuit may adjust the power of the transmitted signal in accordance with the received signal from the receivers of the radar system.

The adjustment circuit may adjust the steering angle of the transmitted signal in accordance with the received signal from the receiver of the radar system.

The adjustment circuit may include at least three timeslots including a first time slot where the adjustment circuit operates in a long distance mode, a second time slot where the adjustment circuit operates in a mid distance mode and a third time slot where the adjustment circuit operates in a near distance mode.

The adjustment circuit may control the operation of the vehicle.

The adjustment circuit may control the steering of the vehicle.

The adjustment circuit may control the breaking of the vehicle.

The long time slot, mid time slot and the near time slot is adjusted based upon the road environment.

The road environment may be curved road.

The road environment may be straight road.

The road environment may be a combination of curved and straight road.

The adjustment circuit may control the speed of the vehicle.

### BRIEF DESCRIPTION OF THE DRAWINGS

The invention may be understood by reference to the following description taken in conjunction with the accompanying drawings, in which, like reference numerals identify like elements, and in which:

FIG. 1a illustrates a circuit diagram of the radar transmission system of the present invention;

FIG. 1b illustrates a transmitter of the radar system of the present invention;

FIG. 2 illustrates the radar system of the present invention and the application to a highway system;

FIG. 3 illustrates the radar system of the present invention mounted in a vehicle;

FIG. 4a illustrates the radar receiver system of the present invention;

FIG. 4b illustrates a portion of a single receiver of the present invention;

FIG. 5-7 illustrates an adaptive range control circuit provides a multitude of different range object detection such as near range, middle range and far range up to at least 200 meter coverage by one radar system via time division scanning.

### DETAILED DESCRIPTION

Significant progress is being made in the quest for providing for driverless vehicles. However, a requirement for a driverless vehicle is to have the ability to detect other vehicles and objects which may be positioned on the roadway ahead of the driverless vehicles. The automobile radar should be sufficiently robust to detect objects in the short, mid and long range with an angular scan do measure distance to an object, form an image of the path ahead, search for automobiles and lock multiple potential targets. The present invention includes radar with multiple beamforming antennas, with signal processing gain, to form a high-resolution image. The present invention includes artificial intelligence for tracking the moving target and assigning a single beam or subset of beams to tracking multiple target simultaneously. Artificial intelligence of the present invention selects the moving target and/or road hazards from the image, and sends the target information (which may include speed of the vehicle, size of the vehicle, etc.) to a central processor to avoid overloading the data-bus. Artificial intelligence based adaptive radar with beam forming provides for a vehicle radar sensor operating like a human brain controlled eye with intelligence. The AI based radar system includes N (N is integer) antennas, each antenna with finely digitally controlled delay line and artificial intelligence block. Antenna output power level (which determines and corresponds to the distance that the antenna can radiate) can be controlled by the antenna system. When the delay or the output power from each antenna changes, the beam angle for each antenna can be adjusted. When a multitude of antennas are turned on and the space between the multitude antennas are changed, beam width, direction (stern angle) and shape can be adjusted for each of the antennas.

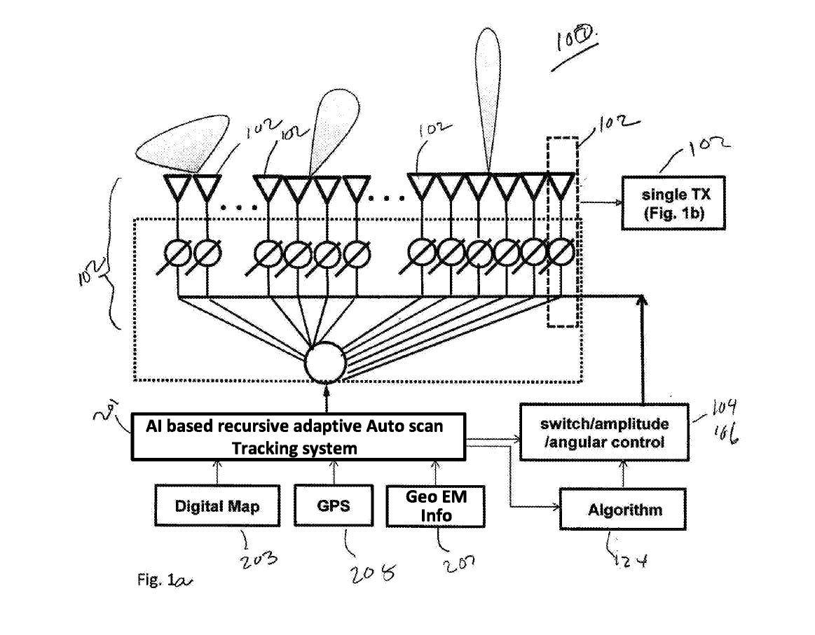

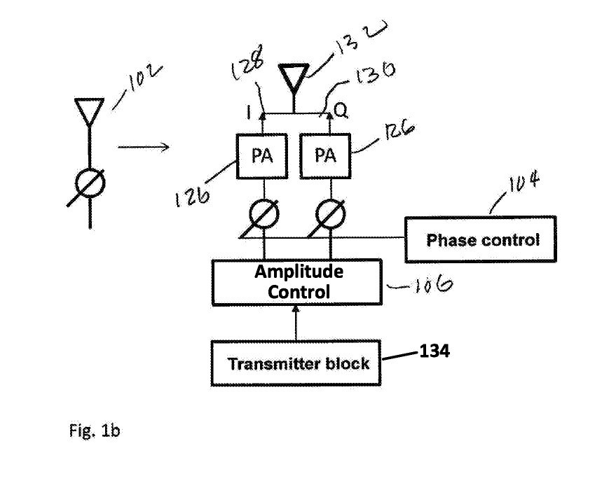

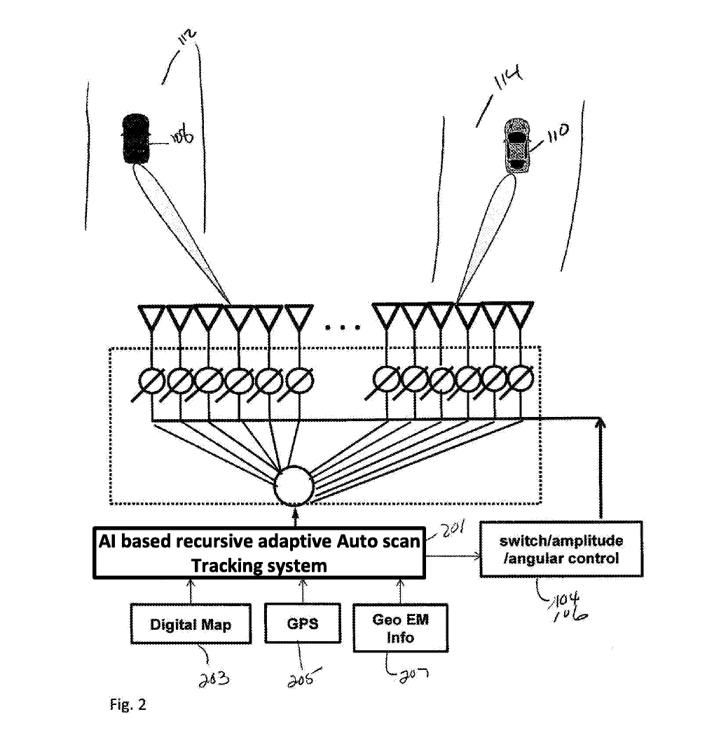

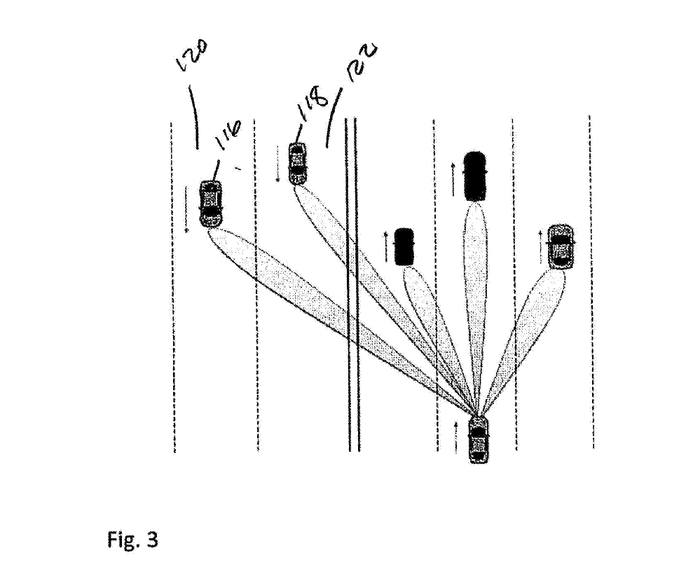

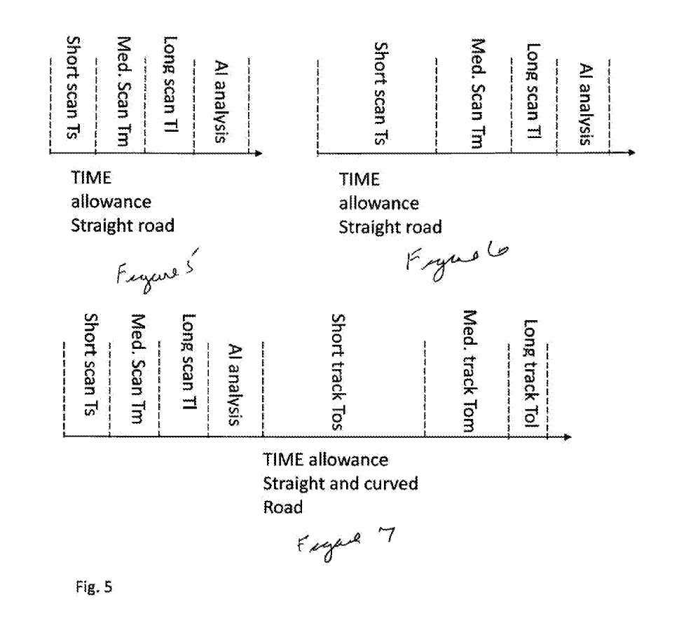

Some of the aspects of the present invention are:
1. The auto radar system which may include a multitude of antennas can adaptively and selectively adjust the radar range, the beam steering angle, the beam width to achieve adaptive high resolution of the localization of a multitude of targets, identifying (using imaging processing) and tracking multiple targets simultaneously (pedestrians, vehicles, road hazards etc). The total N antennas (transmitters) can be divided into m groups (where m is an integer). N_1, N_2, . . . , Nm (With N_l+N_2+ . . . +N_m=N). N_1, N_2, . . . , N_m are dynamically assigned by the AI circuit to be optimized tracking front left and middle and right sides and opposite direction of road. There are m groups of corresponding beam forming transmitters to potentially track m targets. (FIG. 1a). Each antenna driven by antenna/transmitter TX group is shown in FIG. 1b. Each transmitter TX 102 (FIG. 1b) has a separate I and Q channels with an independent phase adjuster 104 and an independent amplitude control 106 for improved control of the phase and the amplitude being transmitted from the transmitter 102. With this configuration, a single radar can track road or highway with multiple vehicles 108, 110 in multiple lanes 112, 114 (as shown in FIG. 2) and multiple vehicles 116, 118 in multiple lanes 120, 122 moving in the opposite direction (FIG. 3). The AI circuit 201 based radar uses a combination of different variable groups of antenna which may be dynamically changed in order to satisfy the needs of the current traffic situation to form multiple and independent radar beams to track cars in different and opposite lanes.
2. The AI base adaptive beam circuit 201 and TX 102 can be implemented by CMOS technology to integrate an RF circuit, a baseband circuit, a digital beamforming circuit and AI circuit in a single chip solution
3. The AI based adaptive beam circuit 201 and TX102 can produce a high resolution millimeter wave image by using both narrow beam and high speed beam scanning to make the objects (radar target) real time identification possible.
4. A localized sensor based AI processor analyzes the millimeter wave image from the AI based adaptive beam circuit 201 and only tracking the moving targets (for speed and size) and road hazards as limited bandwidth information (size) and transmits these limited bandwidth information, rather than full image, back to central processor to avoid overloading the data-bus.
5. Multiple adaptive antenna arrays have the superior anti-interference ability, and high transmission efficiency and high receiver sensitivity.
6. An adaptive range control circuit provides a multitude of different range object detection such as near range, middle range and far range up to at least 200 meter coverage by one radar system via time division scanning such as illustrated in FIGS. 5-7 (diagram time, space scanning) The time division slots for low middle and high range is adaptively controlled by the AI circuit 201 depending on the target object distribution for example the distribution on the roadway, environment for example strait or curved, road conditions, weather conditions etc as inputs to the AI circuit 201.

For the vehicle radar application, the AI circuit 201 may include short, middle and long distance applications. (For the following integer: N1<N2<N)

1. N1 numbers of antennas are used, the beam width of the antennas is large, the antenna scans the beam angle, to form the short distance wide scanning angle application,
2. N2 numbers of antennas are used, the beam width of the antennas is medium by being larger than N1 and smaller than N, the antennas scan the beam angle, to form the middle distance medium scanning angle application,
3. N numbers of antennas are used, the beam width of the antennas is narrow, the antennas scan the beam angle, to form the long distance narrow scanning angle application.

The AI circuit (which may be an adjustment circuit to adjust the transmitted signal) 201 perception: Based on sensor-received information, the AI circuit 201 learns the situation with respect to vehicles and environment makes an evaluation and a decision to target and lock-in several selected spots and lock-in vehicles which are needed to be tracked and monitored based on the effect the target vehicle and object present to the driverless car. The AI circuit 201 adjusts the beam width and power and steering angle in response to the data from the sensors in order to respond to the surrounding environment and situation. The AI circuit 201 selects and scans the most safety concerned targets, or to adjust different time interval, choose to scan the whole environment with short, middle and long range.

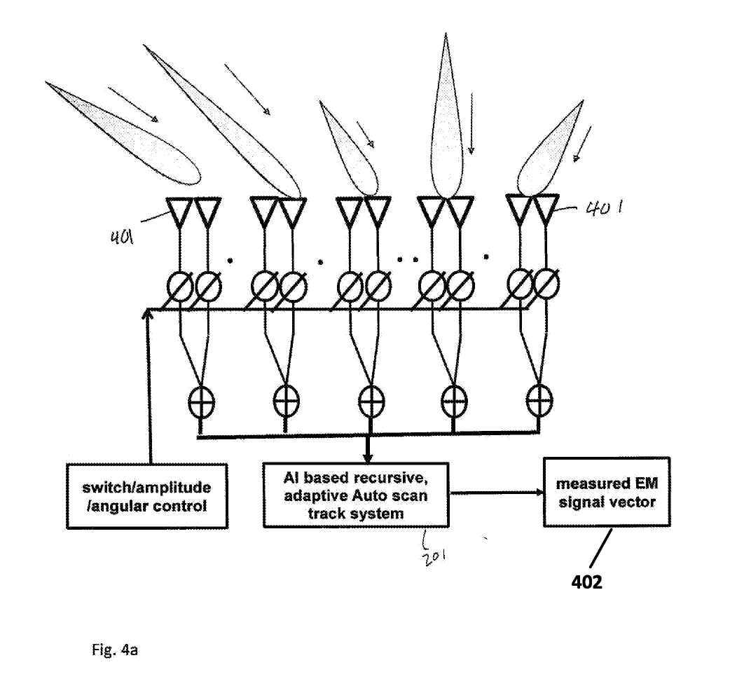

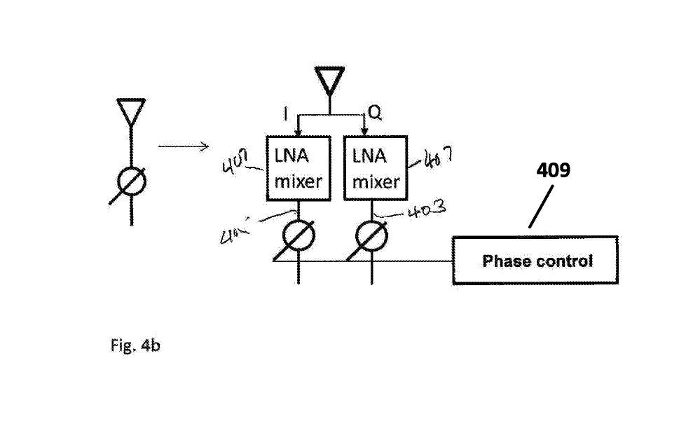

FIG. 4 illustrates the reflected signals being received by the antennas 401 and received by the AI circuit 201 which may be referred to as an adjustment circuit. Thus, the AI circuit 201 determines and selects the distance, angle and beam shape to monitor the vehicles and the surrounding environment. Based on imaging information, the AI circuit 201 instructs the controlled vehicle to take actions such as steering, braking, etc. AI control algorithm and time allowance is as following (FIG. 4):
1. Within 200 m, there is no pedestrians, auto, objective, etc. in front of car.
   a. In straight road, the radar system 100 will sequentially scan short, T_s middle T_m, and long range T_l or in any combination order with a time slot of T_s, T_m, T_l. T_s, T_m, T_l where the timeslots are substantially equal for the straight road. One scanning cycle T=T_s+T_m+T_l.
   b. In curved road and dependent on the curve radius, the AI controller 201 dynamically assigns the length of the time slot: short range radar have the large scanning time slot because of the close proximity of other vehicles and obstacles; middle range has middle length of the time slot because of the longer proximity of other vehicles and obstacles; and long range has short length of the time slot because the proximity of the vehicles and obstacles have a minimum impact on the vehicle with the radar. (T_s>T_m>T_l). The length of the entire scanning cycle T=T_s+T_m+T_l.
2. When there are cars or other objects in front of road for both straight and curved road, the AI circuit 201 assigns the following:
   a. If the object is between 50 m-200 m for example the longest distance from the vehicle with the radar, the AI circuit 201 assigns tracking time slot T_ol the time slot of the object long range. Usually, T_ol=T_l
   b. If object is positioned between 30 m-50 m, the AI circuit 201 assigns tracking time slot T_om the timeslot of the object middle range. The AI controller 201 needs to better track the image, the distance and the speed of the objects. Usually, T_om=2*T_m (in this example)
   c. If object is within 30 m (a short distance, the AI controller 201 assigns tracking time slot T_os the timeslot of objects within a short distance. Usually, the AI circuit 201 needs to track the track image, distance and speed of the objects the best in this situation because these objects are the closest to the vehicle with the radar. T_os=4-8*T_s (for example) depending on how close the objects are and the relative velocity of the objects.
3. Thus, entire scanning cycle may be T=(T_s+T_m+T_l)+(T_ol+T_om+T_os).

FIG. 1a. Illustrates the AI circuit 201 having auto scan and tracking capabilities and connected to a multitude of transmitters 102 based radar multiple range scan capability. The AI circuit 201 may receive input from a digital map circuit 203 which may input a digital map of the area that the vehicle is traveling in, a global positioning signal GPS circuit 205 to input a digital location of the vehicle and a geographical electronic magnetic information circuit 207 to input electric magnetic information. In addition, FIG. 1a shows an amplitude control circuit 106 to control the amplitude of the signal radiated from the transmitter 102 and an angular control circuit 106 to control the angle of the signal radiated from the transmitter 102. The amplitude control circuit 106 and the phase adjuster circuit 104 are controlled by the AI circuit 201 by the recursive analysis circuit 124. Radar transmitter 102 transmits simultaneously for wide-angle short-range with least number of transmitters 102, in sequence the medium-angle middle range transmitters 102 with medium number of transmitters and transmits following the short range transmitters, in sequence the long range transmitters 102 transmits at narrow-angle long-range scan/imaging and locking with large number of transmitters.

Each antenna controlled by a transmitter 102 (as TX, shown in FIG. 1b). The entire antenna array is controlled by artificial intelligence AI circuit 201 with auto scan and tracking function. With the input information from the GPS circuit 205, the digital map circuit 203, the measured geographic electro-magnetic wave information circuit 207, the AI circuit 201 generates targeted beams to be transmitted by the transmitters 102 by selecting and switching multiple groups of TX transmitters 102 with desired amplitude and angular determined by the AI circuit 201.

FIG. 1b illustrates the functional blocks of transmitter (TX). TX transmitter 102 may include an I channel 128 and Q channel 130 with power amplifiers (PA) 126 for each channel to drive an antenna 132. Each channel 128, 130 with independent phase adjuster control circuit 104 and amplitude control circuit 106 and a transmitter block 134.

FIG. 2 illustrates that the radar system detects multiple targets of interest such as vehicles 108, 110 in in lanes 112, 114 and execute target locking. This is another function of AI based radar. (See. FIG. 4)

FIG. 3 shows a vehicle radar that tracks 5 different lane road with 2 opposing driving lanes 120, 122. The AI circuit 201 based radar tracks the 5 closest vehicles (which are the highest safety concerns) in 5 different lanes.

FIG. 4a shows tracking radar receiver system with 5 groups of antenna/transmitter (FIG. 4a), the AI circuit 201 based radar receiver 401 generates corresponding to 5 antenna/receiver groups to receive and process 5 groups of radar signal simultaneously and generating measured EM signal vector 402 and do the tracking job. Each receiver 401 has an I channel 403 and a Q channel 405 with LNA/mixer 407 and phase control 409 (FIG. 4b). The signal processor AI 201 has recursive adaptive LMS algorithm to identify and tracking the targets. Additionally antenna/receiver groups may be reserved for general scan and tracking purpose.

FIGS. 5, 6 and 7 illustrates the time slots for various radar scanning and tracking time allowance for (a) straight road without objects, (b) curved road without objects, (c) straight and a curved road with objects.

FIG. 5 illustrates the time slots for a straight road and illustrates that there are approximately equal slots for the short scan, medium scan, long scan and AI circuit analysis of the received signals.

FIG. 6 illustrates the time slot for a curved road and illustrates that the short scan has been given a longer time slot then the medium scan or the long scan.

FIG. 7 illustrates the time slots for a straight and curved road showing a first sequence of timeslots being approximately equal and then a second sequence of timeslots having the short scan longer than the remaining scans.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A radar system to track objects for a vehicle, comprising:
a plurality of transmitters to transmit a signal;
a plurality of receivers to receive the signal;
a adjustment circuit to adjust the bandwidth of the transmitted signal in accordance with the received signal from the receivers of the radar system,

2) A radar system to track objects for a vehicle as in claim 1, wherein the adjustment circuit adjusts the power of the transmitted signal in accordance with the received signal from the receivers of the radar system.

3) A radar system to track objects for a vehicle as in claim 2, wherein the adjustment circuit adjusts the steering angle of the transmitted signal in accordance with the received signal from the receiver of the radar system.

4) A radar system to track objects for a vehicle as in claim 1, wherein the adjustment circuit includes at least three timeslots including a first time slot where the adjustment circuit operates in a long distance mode, a second time slot where the adjustment circuit operates in a mid distance mode and a third time slot where the adjustment circuit operates in a near distance mode.

5) A radar system to track objects for a vehicle as in claim 4, wherein the adjustment circuit controls the operation of the vehicle.

6) A radar system to track objects for a vehicle as in claim 5, wherein the adjustment circuit controls the steering of the vehicle.

7) A radar system to track objects for a vehicle as in claim 5, wherein the adjustment circuit controls the breaking of the vehicle.

8) A radar system to track objects for a vehicle as in claim 4, wherein the long time slot, mid time slot and the near time slot is adjusted based upon the road environment.

9) A radar system to track objects for a vehicle as in claim 8, wherein the road environment is curved road.

10. A radar system to track objects for a vehicle as in claim 8, wherein the road environment is straight road.

11) A radar system to track objects for a vehicle as in claim 8, wherein the road environment is a combination of curved and straight road.

12) A radar system to track objects for a vehicle as in claim 5, wherein the adjustment circuit controls the speed of the vehicle.
